(19) United States
(12) Patent Application Publication
(10) Pub. No.: US 2025/0138377 A1
(43) Pub. Date: May 1, 2025

(54) OPTICALLY TRANSPARENT POLYMERIC ION CONDUCTIVE LAYERS FOR ELECTROCHROMIC DEVICES

(71) Applicant: DelStar Technologies, Inc., Alpharetta, GA (US)

(72) Inventor: Nandan Ukidwe, Suffield, CT (US)

(21) Appl. No.: 18/926,719

(22) Filed: Oct. 25, 2024

Related U.S. Application Data
(60) Provisional application No. 63/593,685, filed on Oct. 27, 2023.

(51) Int. Cl. G02F 1/1516; G02F 1/1523

(52) U.S. Cl. CPC G02F 1/15165; G02F 1/1525

(57) ABSTRACT

Polymeric ion conductive layers and electrochromic devices utilizing the same are described. The polymeric ion conductive layer may include a polymer having a Shore hardness of greater than 80A, an electrolyte dispersed in the polymer, and a plasticizer dispersed in the polymer. The polymeric ion conducive layer may have no creep at elevated temperatures. The polymeric ion conductive layer may have an ionic conductivity of greater than or equal to about 1E-5 S/cm, a haze of less than 3%, and a light transmission of greater than or equal to about 80%. An electrochromic device may include a first optically transparent layer, a second optically transparent layer, and electrochromic layers including the polymeric ion conductive layer interposed between the first and second optically transparent layers.

### CROSS-REFERENCE TO RELATED APPLICATIONS

This application claims priority to U.S. Provisional Patent Application No. 63/593,685 filed on Oct. 27, 2023, the contents of which are incorporated herein by reference to the extent consistent with the present disclosure.

### TECHNICAL FIELD

This description generally relates to electrochromic devices, ion conductive layers thereof, and methods for the same.

### BACKGROUND

“Smart glass” or “smart windows” utilize or incorporate electrochromic devices to adjust light transmission, color, and/or reflective characteristics thereof via electronic switching or electrochromism. Smart windows may be utilized in buildings and transportation (e.g., automobiles, trains, etc.) to regulate the transmission of solar energy (e.g., heat and light) and thereby improve the energy efficiency of the buildings and transportation. Conventional electrochromic devices may often utilize a polymeric ion conductive layer prepared from a thermoplastic, such as thermoplastic polyurethane (TPU), a plasticizer, and an electrolyte or salt, to provide ion conductivity between electrochromic layers of the electrochromic devices. While conventional polymeric ion conductive layers have provided more than sufficient performance at room temperature, recent trends have focused on improving their performance (e.g., mechanical performance, etc.) at elevated temperatures.

### BRIEF SUMMARY

This following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

The foregoing and/or other aspects and utilities described herein may be achieved by providing a polymeric ion conductive layer for an electrochromic device. The polymeric ion conductive layer may include a polymer having a Shore hardness of greater than 80 A, an electrolyte dispersed in the polymer, and a plasticizer dispersed in the polymer. The polymeric ion conductive layer may have no creep, as measured according to the procedures described herein and/or ASTM C1172, at about 85° C.

In one aspect, the polymer may have a Shore hardness of greater than 87 A.

In one aspect, the polymer may have a Shore hardness of greater than or equal to 55 D.

In one aspect, the polymer may have a Shore hardness of greater than or equal to 60 D.

In one aspect, the polymer may have a Shore hardness of greater than or equal to 67 D.

In one aspect, the polymer may have a Shore hardness of greater than or equal to 72 D.

In one aspect, the polymer may have a Shore hardness of greater than or equal to 80 D.

In one aspect, the polymeric ion conductive layer may have no creep as measured according to the procedures described herein and/or ASTM C1172, at about 85° C. for at least 24 hours.

In one aspect, the polymeric ion conductive layer may have an ionic conductivity of greater than or equal to about 1E-5 Siemens/cm (S/cm), greater than or equal to about 3.5E-5 S/cm, greater than or equal to about 4E-5 S/cm, greater than or equal to about 1E-4 S/cm, greater than or equal to about 2E-4 S/cm, greater than or equal to about 3E-4 S/cm.

In one aspect, the polymeric ion conductive layer may have a light transmission, as measured according to reference test ASTM-D1003, of greater than or equal to about 80%.

In one aspect, the polymeric ion conductive layer may have a haze, as measured according to reference test ASTM-D1003, of less than 3%.

In one aspect, the polymeric ion conductive layer may have a haze, as measured according to reference test ASTM-D1003, of less than 2%.

In one aspect, the polymeric ion conductive layer may have a peel strength of greater than 25 N/mm, as measured according to ASTM D3167.

In one aspect, the polymer may include a thermoplastic polymer.

In one aspect, the polymer may include a thermoplastic polyurethane.

In one aspect, the thermoplastic polyurethane may include an aliphatic polyether thermoplastic polyurethane.

In one aspect, the thermoplastic polyurethane may include a blend of two or more aliphatic polyether thermoplastic polyurethanes.

In one aspect, the electrolyte may include a lithium salt. The lithium salt may include one or more of lithium chloride (LiCl), lithium fluoride (LiF), lithium iodide (LiI), lithium nitrate (LiNO₃), lithium perchlorate (LiClO₄), lithium tetrafluoroborate (LiBF₄), lithium hexafluorophosphate (LiPF₆), lithium hexafluoroarsenat (V) (LiAsF₆), lithium triflate, lithium imide, lithium bis(trifluoromethanesulfonyl)imide (LiTFSI) salt, lithium 2-trifluoromethyl-4,5-dicyanoimidazolide (LiTDI), or a combination thereof.

In one aspect, the plasticizer may be present in an amount of greater than or equal to about 40 wt %, based on the total weight of the polymeric ion conductive layer.

In one aspect, the plasticizer may be present in an amount of greater than or equal to about 42 wt %, based on the total weight of the polymeric ion conductive layer.

In one aspect, the plasticizer may be present in an amount of greater than or equal to about 45 wt % to about 65 wt %, based on the total weight of the polymeric ion conductive layer.

In one aspect, a difference between a Hansen Solubility Parameter of the polymer and a Hansen Solubility Parameter of the plasticizer, also referred to as an HSP Distance or “Ra”, may be less than or equal to about 5.

In one aspect, a difference between a Hansen Solubility Parameter of the polymer and a Hansen Solubility Parameter of the plasticizer (Ra) may be less than or equal to about 3.8.

In one aspect, the plasticizer may include one or more of propylene carbonate, ethylene carbonate, triethylene glycol bis(2-ehtylhexanoate) (TEG-EH), or any combination thereof.

In one aspect, the plasticizer may include a combination of propylene carbonate and triethylene glycol bis(2-ehtylhexanoate) (TEG-EH).

In one aspect, the plasticizer may include a combination of ethylene carbonate, propylene carbonate, and triethylene glycol bis(2-ehtylhexanoate) (TEG-EH).

The foregoing and/or other aspects and utilities described herein may be achieved by providing an electrochromic device including a first optically transparent layer, a second optically transparent layer, and electrochromic layers interposed between the first and second optically transparent layers. The electrochromic layers may include any one of the foregoing polymeric ion conductive layers.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the subject matter and, together with the description, serve to explain the principles thereof.

FIG. 1 is a schematic cross-sectional view of an exemplary electrochromic cell or device, according to one or more implementations described herein.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically included.

As used herein, “free” or “substantially free” of a material may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition with a cited reference, the present teachings control.

The present inventors have surprisingly and unexpectedly discovered that polymeric ion conductive layers including a polymer having a Shore hardness of about 80 A or less and a plasticizer in an amount of about 35 wt % resulted in complete delamination from a substrate at elevated temperatures; and thus, complete failure in an electrochromic device. The complete delamination was demonstrated with varying plasticizers and the polymer having a Shore hardness of about 80 A or less. It was also surprisingly and unexpectedly discovered that utilizing a polymer having a Shore hardness of greater than 80 A or greater than 87 A, and a plasticizer in an amount of about 35 wt % resulted in no creep when adhered to a substrate at the same elevated temperature. The results of no creep were demonstrated with the polymer having a Shore hardness of greater than 80 A or greater than 87 A, and varying plasticizers. It was further surprisingly and unexpectedly discovered that increasing the amount of the plasticizer or a plasticizer blend to about 50 wt % resulted in a significant increase in ion conductivity as compared to polymeric ion conductive layers including the plasticizer in an amount of about 35 wt % at the same ambient temperature.

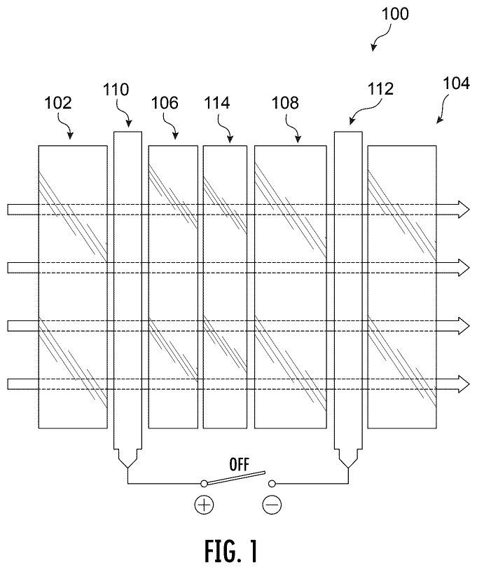

FIG. 1 illustrates an exploded cross-sectional view of an exemplary electrochromic cell or device 100, according to one or more implementations described. The electrochromic device 100 may include one or more substrates, which may be optically transparent layers or sheets, and one or more electrochromic layers disposed on the substrate or interposed between the substrates. For example, the electrochromic device 100 may include one or more optically transparent layers or sheet 102, 104, one or more electrochromic (EC) layers 106, 108, one or more transparent oxide layers 110, 112, one or more ion conductive layers 114, or any combination thereof. As illustrated in FIG. 1, the electrochromic device 100 may include two optically transparent layers 102, 104, two EC layers 106, 108 interposed between the optically transparent layers 102, 104, two transparent oxide layer 110, 112 interposed between the optically transparent layers 102, 104, and an ion conductive layer 114 interposed between the EC layers 106, 108. It should be appreciated that each of the components of the electrochromic device 100, the orientation or disposition thereof, and the respective functions thereof are known to one having ordinary skill in the art.

The optically transparent layers 102, 104 may include any suitable transparent and/or rigid material, and may be selected, at least in part, by the application for the electrochromic device 100. For example, each of the optically transparent layers 102, 104 may independently be or include, but is not limited to, glass, polycarbonate, tempered glass, laminated glass, engraved glass, polymeric sheet, a rigid outer ply, a ceramic, an acrylic, polyethylene terephthalate (PET), a polyphosphonate, or the like, or any combination thereof.

The EC layers 106, 108 may be or include mixed conductors that may be capable of or configured to conduct ions and electrons. The EC layers 106, 108 may be or include, but are not limited to, transition metal oxides, transition metal complexes, conducting polymers, viologens, polyaniline, polythiophene, tungsten oxide (WO₃), Prussian Blue, or the like, or any combination thereof. At least one of the EC layers 106, 108 may be or include a cathodic electrochromic conducting polymer, and at least one of the EC layers 106, 108 may be or include an anodic electrochromic conducting polymer. For example, a first EC layer 106 may be or include the anodic electrochromic conducting polymer, and a second EC layer 108 may be or include the cathodic electrochromic conducting polymer. Illustrative anodic electrochromic conducting polymers may be or include, but are not limited to, bis(2-(3,4-ethylenedioxy) thienyl)-N-methyl carbazole polymer (BEDOT-NMCz), PPro-NPrS, derivatives thereof, or the like, or any combination thereof. Illustrative cathodic electrochromic conducting polymers may be or include, but are not limited to, PEDOT, PProDOT, PEDOP, PTT, PAEM-EDOT, or the like, or any combination thereof.

The transparent oxide layers 110, 112 may be disposed adjacent the optically transparent layers 102, 104, respectively. The transparent oxide layers 110, 112 may be or include any suitable material capable of or configured to conduct electrons, such as metal oxides. The transparent oxide layers 110, 112 may have a relatively low absorption of light. Illustrative transparent oxide layers 110, 112 may be or include, but are not limited to, indium oxide, indium tin oxide, silicon oxide, or the like, or any combination thereof. The transparent oxide layers 110, 112 or the metal oxides thereof may be doped with one or more of fluorides, antimony, or aluminum to improve the conductivity thereof. It should be appreciated that other transparent conductive materials may be utilized for the transparent oxide layers 110, 112, including, but not limited to, PEDOT/PSS, carbon nanotube, coatings or layers thereof, or any combination thereof.

The ion conductive layer 114 may be capable of or configured to provide a medium for the exchange of ions between two or more electrodes or electrode materials. The ion conductive layer 114 may be or include one or more polymers, one or more electrolytes, one or more salts, one or more plasticizers, or any combination thereof. For example, the ion conductive layer 114 may be a polymeric ion conductive layer including a combination of one or more polymers, one or more electrolytes, and one or more plasticizers. The polymeric ion conductive layer 114 may be a solid or a gel. In an exemplary implementation, the polymeric ion conductive layer 114 includes one or more polymers or polymer blends, and a plasticizer and a salt dispersed or otherwise combined with the one or more polymers or polymer blends. The salt may be capable of or configured to provide electrolyte properties to the polymeric ion conductive layer 114. The salt may be combined with the one or more plasticizers prior to combining with the polymer or polymer blend. The salt may be combined with the plasticizer via one or more solvents, such as an organic solvent and/or an aqueous solvent. The salt may be present in an amount of from about 1 wt % to about 25 wt %, based on the total weight of the polymeric ion conductive layer 114. The salt may be combined with the plasticizer in an amount of from about 0.1M to about 2M. The plasticizer may be present in an amount of from about 5 wt % to about 65 wt %, based on the total weight of the polymeric ion conductive layer 114. The one or more polymers and/or the polymer blends may make up the balance of the polymeric ion conductive layer 114. Each of the components of the polymeric ion conductive layer 114 may form a homogenous, generally colorless, and/or clear composition.

The polymeric ion conductive layer 114 may have a thickness that depends, at least in part, on the application of the electrochromic device 100 or one or more components thereof. In at least one implementation, the polymeric ion conductive layer 114 may have a thickness of from about 100 μm to about 2000 μm. For example, the polymeric ion conductive layer 114 may have a thickness of from about 100 μm to about 2000 μm, about 100 μm to about 1500 μm, or about 150 μm to about 1000 μm.

The components of the polymeric ion conductive layer 114 may be selected to provide sufficient mechanical, conductive, and/or optical properties. For example, the components of the polymeric ion conductive layer 114 may provide an ionic conductivity sufficient for a switching speed of less than 5 minutes (min), less than 1 min, or less than 30 seconds. As used herein, the term or expression “switching speed” may refer to the time elapsed for an electrochromic device to change from the optical density thereof from a fully bleached state to a fully colored state. In another example, the components of the polymeric ion conductive layer 114 may provide sufficient mechanical adhesion to one or more components of the electrochromic device 100 such that there is no or minimal creep therebetween. In yet another example, the components of the polymeric ion conductive layer 114 may provide an optically transparent electrochromic device 100.

The polymeric ion conductive layer 114 may have an ionic conductivity of about 1E-6 Siemens/cm (S/cm) or greater. For example, the polymeric ion conductive layer 114 may have an ionic conductivity of from greater than or equal to about 1E-6 S/cm, greater than or equal to about 1E-5 S/cm, greater than or equal to about 3.5E-5 S/cm, greater than or equal to about 4E-5 S/cm, greater than or equal to about 1E-4 S/cm, greater than or equal to about 2E-4 S/cm, greater than or equal to about 3E-4 S/cm, or more.

The polymeric ion conductive layer 114 may have a transmittance of greater than or equal to about 80%, greater than or equal to about 85%, greater than or equal to about 90%, greater than or equal to about 91%, greater than or equal to about 92%, greater than or equal to about 93%, greater than or equal to about 94%, or more. As used herein, the term or expression “transmittance” may refer to a ratio of the radiant power transmitted through a material or device to the incident radiant power.

The polymeric ion conductive layer 114 may have a haze, as measured according to reference test ASTM-D1003 of the American Society for Testing and Materials (ASTM), of less than or equal to about 5%. For example, the polymeric ion conductive layer 114 described herein may have a haze, as measured according to ASTM-D1003 of greater than 0 and less than or equal to about 5%, less than or equal to about 4%, less than or equal to about 3%, less than or equal to about 2%, less than or equal to about 1.5%, less than or equal to about 1.4%, less than or equal to about 1.3%, less than or equal to about 1.2%, less than or equal to about 1.1%, less than or equal to about 1%, or less than or equal to about 0.7%.

The polymeric ion conductive layer 114 may have a light transmission, as measured according to reference test ASTM-D1003 of the American Society for Testing and Materials (ASTM), of greater than or equal to about 80%, greater than or equal to about 82%, greater than or equal to about 84%, greater than or equal to about 86%, greater than or equal to about 88%, greater than or equal to about 90%, greater than or equal to about 91%, greater than or equal to about 92%, greater than or equal to about 93%, greater than or equal to about 94%, or more.

The polymeric ion conductive layer 114 may have no or substantially no creep, as measured according to the procedures described herein and/or ASTM C1172, at about 85° C. For example, the polymeric ion conductive layer 114 may not have or exhibit any creep or displacement when measured according to the procedures described herein and/or ASTM C1172, at about 85° C. The creep may be measured at temperatures of about 85° C. or more for at least 24 hours.

The polymeric ion conductive layer 114 may have a peel strength of greater than 25 N/mm, as measured according to ASTM D 3167. For example, the polymeric ion conductive layer 114 may have a peel strength of greater than 25 N/mm, greater than 30 N/mm, greater than 35 N/mm, greater than 40 N/mm, or more.

The polymeric ion conductive layer 114 may include one or more fillers. Illustrative fillers may be or include, but are not limited to, particles having an average particle size of from about 1 nm to about 20 μm. The filler be present in an amount and/or have a particle size sufficient to provide the polymeric ion conductive layer 114 a light transparency of greater than 80%. Illustrative fillers may be or include, but are not limited to, polystyrene, polycarbonate, PMMA, glass powder, glass nanoparticles, inorganic oxides, mixed oxides, or the like, or any combination thereof.

The performance of the electrochromic device 100 may be evaluated in terms of switching times and transparency (or transmission contrast) under different humidity and temperature conditions. These electrochromic devices 100 may be tested at reduced pressures. A cycling voltage to operate the electrochromic device 100 may be determined by cycling the electrochromic device 100 at different voltages and monitoring changes in the % T in the clear state after a number of cycles. Potential cycling or stepping may be used to identify the preferred device voltage for a desired operating life.

The one or more components of the electrochromic device 100 may also be selected to provide sufficient extrudability such that the composition of the electrochromic device 100 may be extruded with one another together to form the final electrochromic device 100. For example, the components of the EC layers 106, 108, the transparent oxide layers 110, 112, and/or the ion conductive layers 114 may be selected such that the combination may be extruded on the optically transparent layers 102, 104 to prepare the electrochromic device 100. Extrudability is the energy sufficient to push or force something through an extruder, such single and twin-screw machines, co-rotating or counterrotating, closely intermeshing twin-screw compounders or the like. The components selected in herein provide sufficient optical transparency, ion conductivity, adhesion, and extrudability.

The one or more polymers or polymer blends of the polymeric ion conductive layer 114 may be capable of or configured to provide sufficient transparency or transmission of visible light, suitable adhesion to a substrate or component of the polymeric ion conductive layer 114, and/or ionic conductivity. Illustrative polymers and polymer blends may be or include, but are not limited to, one or more of a thermoplastic polymer, an acrylic polymer, such as polymethylmethacrylate (PMMA), polyolefins, polyesters, polycaprolactones, such as polyethylene terephthalate or polybutylene terephthalate, a thermoset polymer, or the like, or blends thereof, or any combination thereof. In an exemplary implementation, the polymer includes a thermoplastic polymer, such as thermoplastic polyurethane (TPU), or a blend thereof. Illustrative thermoplastic polyurethanes may be or include, but are not limited to, one or more of a polyether-based thermoplastic polyurethane, an aliphatic polyether TPU, a TPU resin blend, or the like, or any combination thereof. For example, the TPU may be or include ESTANE AG-8451 TPU (an aliphatic polyether TPU commercially available from Lubrizol Corporation of Wickliffe, OH), TEXIN® 8980 D (an aliphatic polyether TPU commercially available from Covestro, LLC. of Leverkusen, Germany), TEXIN® 8955DE (an aliphatic polyether TPU commercially available from Covestro, LLC of Leverkusen, Germany), ELASTOLLAN® L 760 D (an aliphatic polyester TPU having a Shore hardness of about 60 D and commercially available from BASF of Ludwigshafen, Germany), TECOFLEX® EG-72 D (an aliphatic polyether TPU commercially available from Lubrizol Corporation of Wickliffe, OH), ESTANE® ALR TPU (an aliphatic based TPU commercially available from Lubrizol Corporation), or the like, or any combination thereof.

The one or more polymers or polymer blends may have a Shore hardness of greater than 80 A. For example, the polymer or polymer blend may have a Shore hardness of greater than 80 A, greater than or equal to about 87 A, greater than or equal to about 51 D, greater than or equal to about 55 D, greater than or equal to about 60 D, greater than or equal to about 67 D, greater than or equal to about 72 D, greater than or equal to about 80 D, or greater than or equal to about 85 D. In at least one implementation, the one or more polymers or polymer blends may have a Shore hardness of less than or equal to about 100 D, less than or equal to about 95 D, or less than or equal to about 90 D.

The salt or electrolyte of the polymeric ion conductive layer 114 may be or include an alkali earth metal salt, an alkaline earth metal salt, organic salts, or any combination thereof. Illustrative salts or electrolytes may be or include, but are not limited to, one or more of lithium salts, lithium halides, lithium-metal salts, lithium chloride (LiCl), lithium fluoride (LiF), lithium iodide (LiI), lithium nitrate (LiNO₃), lithium perchlorate (LiClO₄), lithium tetrafluoroborate (LiBF₄), lithium hexafluorophosphate (LiPF₆), lithium hexafluoroarsenat (V) (LiAsF₆), lithium triflate, lithium perchlorate, lithium imide, lithium bis(trifluoromethanesulfonyl)imide (LiTFSI) salt, lithium 2-trifluoromethyl-4,5-dicyanoimidazolide (LiTDI), other lithium compounds, sodium octylsulfate, lithium dodecylbenzenesulfate, or any combination thereof. The one or more salts or electrolytes may be present in an amount of from about 1 wt % to about 25 wt % or about 40 wt %, based on the total weight of the polymeric ion conductive layer 114, or the plasticizer and the salt thereof. The one or more salts or electrolytes may be present in the plasticizer in an amount of from about 0.1 M to about 2 M, about 0.5 M to about 1.5 M, or about 1 M. For example, the one or more salts or electrolytes may be present in the plasticizer in an amount of from about 0.1 M, about 0.2 M, about 0.5 M, about 0.7 M, about 0.8 M, about 0.9 M to about 1.0 M, about 1.1 M, about 1.2 M, about 1.5 M, about 1.8M, about 1.9M, or about 2 M.

The plasticizer of the polymeric ion conductive layer 114 may be or include, but is not limited to, one or more organic solvents, such as a carbonate solvent, a lactone solvent, or the like, or any combination thereof. The organic solvent may be selected from a material that provides sufficient ionic conductivity to provide a suitable switching speed for the electrochromic device 100. The organic solvent may be or include, but is not limited to, an organic carbonate solvent, a lactone solvent, or any combination thereof. Illustrative lactone solvents may be or include, but are not limited to, propiolactones, butyrolactones, crotonolactones, valerolactones, or the like, or any mixture or combination thereof. Illustrative organic carbonate solvents may be or include, but are not limited to, diethyl carbonate, propylene carbonate, ethylene carbonate, gamma butyrolactone, dimethyl carbonate, methyl ethyl carbonate, glycerin carbonate, butylene carbonate, alkylene carbonate, or the like, or any combination thereof. In an exemplary implementation, the organic carbonate solvent includes one or more of diethyl carbonate, propylene carbonate, ethylene carbonate, or any combination thereof. Illustrative plasticizers may also be or include, but are not limited to, one or more of a benzoate, a monobenzoate, a dibenzoate, an acrylate monomer, a phthalate, an aliphatic ester, a non-aliphatic ester, an ethylene glycol bis, a trimellitate, a sebacate, an adipate, a terephthalate, a gluterate, a glyceride, an azelate, a maleate, an epoxidized soybean oil, glycols and/or polyethers, including but not limited to, triethylene glycol dihexanoate (3G6), tetraethylene glycol diheptanoate (4G7), triethylene glycol bis(2-ethyl hexanoate) (TEG-EH), tetra ethylene glycol bis(2-ethyl hexanoate) (4GEH), and polyethylene glycol bis(2-ethylhexanoate) (PEG-EH), organophosphates, including but not limited to, tricresyl phosphate (TCP) and tributyl phosphate (TBP), alkyl citrates, glycerol, acetylated monoglycerides, or the like, or any combination or mixture thereof. Additional plasticizers may be or include, but are not limited to, one or more of esters of organic acids, such as esters of adipic acid or phthalic acid, esters of inorganic acids, such as esters of boric acid, carbonic acid, sulfuric acid and phosphoric acid, ethers, such as dibutyl ether, dihexyl ether, diheptyl ether, or the like, or any combination thereof. Illustrative plasticizers may also be or include, but are not limited to, one or more of 3,3′-Oxybis(1-propanol)dibenzoate, BENZOFLEX® 9-88 SG (commercially available from Eastman Chemicals), di-trimethylolpropane tetraacrylate, triallyl isocyanurate, SR35 (commercially available from Sartomer), SR533 (commercially available from Sartomer), Rhodiasolve IRIS (an oxygenated solvent commercially available from Solvay), or the like, or any combination thereof.

In an exemplary implementation, the plasticizer may include at least one carbonic solvent and an additional plasticizer material capable of or configured to increases the optical transparency of the polymeric ion conductive layer 114. The additional plasticizer may be another organic carbonate, such as diethyl carbonate, propylene carbonate, or ethylene carbonate.

In at least one implementation, the plasticizer may be or include a combination of one or more of propylene carbonate, ethylene carbonate, triethylene glycol bis(2-ehtylhexanoate) (TEG-EH), or any combination thereof. In an exemplary implementation, the plasticizer may be or include a combination of propylene carbonate and triethylene glycol bis(2-ethylhexanoate) (TEG-EH). The propylene carbonate and triethylene glycol bis(2-ethylhexanoate) (TEG-EH) may be present in an amount of about 66/34% v/v, respectively. In another implementation, the plasticizer may be or include a combination of ethylene carbonate, propylene carbonate, and TEG-EH. The ethylene carbonate, propylene carbonate, and TEG-EH may be present in an amount of about 30/30/40% v/v respectively. While the foregoing discloses particular ratios and/or amounts of the plasticizers, it should be appreciated that the amount of any one of the plasticizers relative to any one or more of the remaining plasticizers may be present in a ratio (e.g., volume or weight) of from about 10:1 (i.e., about 10 to about 1) to about 1:10. For example, a volume or weight ratio of a first plasticizer to a second plasticizer may be from about 10:1, about 9:1, about 8:1, about 7:1, about 6:1, about 7:1, about 6:1, about 5:1, about 4:1, about 3:1, about 2:1, or about 1:1 to about 1:2, about 1:3, about 1:4, about 1:5, about 1:6, about 1:7, about 1:8, about 1:9, or about 1:10. Any of the foregoing combination of plasticizers may include the salts or electrolytes described herein. For example, the combination of ethylene carbonate, propylene carbonate, and TEG-EH in an amount of about 30/30/40% v/v may include about 1M Lithium bis(trifluoromethanesulfonyl)imide (LiTFSI) salt.

Additional combinations or mixtures of plasticizers may be or include, but are not limited to: (1) a mixture of Benzoflex 9-88 SG and propylene carbonate including about 45% to about 95% Benzoflex 9-88 G (preferably 90% or less) with the remainder including propylene carbonate; (2) a mixture of Benzoflex 9-88 SG and diethyl carbonate including about 50% to about 95% Benzoflex 9-88 G (preferably 90% or less) with the remainder including diethyl carbonate; (3) a mixture of SR355 and ethylene carbonate including about 48% to about 75% SR355 with the remainder including ethylene carbonate; (4) a mixture of Benzoflex 9-88 SG and a 50/50 mixture of propylene carbonate and ethylene carbonate including about 50% to about 95% Benzoflex 9-88 G (preferably 90% or less) with the remainder including the 50/50 mix of ethylene carbonate and propylene carbonate; (5) a mixture of Benzoflex 9-88 SG and a 50/50 mixture of propylene carbonate and diethyl carbonate including about 5% to about 95% Benzoflex 9-88 G (preferably 90% or less) with the remainder including a 50/50 mix of diethyl carbonate and propylene carbonate; (6) a mixture of Benzoflex 9-88 SG and a mixture of 66/33 propylene carbonate and diethyl carbonate including about 20% to about 95% Benzoflex 9-88 G (preferably 90% or less) with the remainder including a 66/33 mix of propylene carbonate and diethyl carbonate; or (7) a mixture of Benzoflex 9-88 SG and a 33/66 mixture of propylene carbonate and diethyl carbonate including about greater than 0% Benzoflex 9-88 G to about 95% Benzoflex 9-88 G (preferably 90% or less) with the remainder of including a 33/66 mix of propylene carbonate and diethyl carbonate. It should be appreciated that any of the foregoing combinations of plasticizers are not exhaustive.

The one or more plasticizers may be present in an amount of from about 5 wt % to about 65 wt %, based on the total weight of the polymeric ion conductive layer 114. For example, the one or more plasticizers may be present in an amount of from about 5 wt %, about 20 wt %, about 30 wt %, about 35 wt %, about 40 wt %, about 45 wt %, about 50 wt %, about 55 wt %, or about 60 wt % to about 65 wt %, based on the total weight of the polymeric ion conductive layer 114. In another example, the one or more plasticizers may be present in an amount sufficient to provide the ionic conductivities described herein. In yet another implementation, the one or more plasticizers may be present in an amount of greater than or equal to about 35 wt %, greater than or equal to about 40 wt %, greater than or equal to about 45 wt %, greater than or equal to about 50 wt %, greater than or equal to about 55 wt %, or greater than or equal to about 60%, based on the total weight of the polymeric ion conductive layer 114. In an exemplary implementation, the plasticizers may be present in an amount of from 40 wt % to about 65 wt % or more, based on the total weight of the polymeric ion conductive layer 114. For example, the plasticizer may be present in an amount of from about 40 wt %, about 41 wt %, about 42 wt %, about 43 wt %, about 44 wt %, about 45 wt %, about 50 wt %, or about 55 wt % to about 60 wt %, or about 65 wt %, based on the total weight of the polymeric ion conductive layer 114.

The polymeric ion conductive layer 114 and/or the one or more components thereof may include one or more additives. For example, the plasticizer may include one or more additives. The additives may be or include one or more of a UV stabilizer or blocker, such as for example UVINUL® or IRGASTAB®, antioxidants, such as IRGANOX®, ULTRANOX® or SICOSTAB®, viscosity modifiers, dispersion auxiliaries, photoinitiators, or the like, or any combination thereof. In another example, the polymeric ion conductive layer 114 may include one or more ionic liquid additives capable of or configured to increase the ionic conductivity of the polymeric ion conductive layer 114 or the plasticizer thereof. Illustrative ionic liquids may be or include, but are not limited to, one or more of 1-Butyl-1-methylpyrrolidinium bis(trifluoromethylsulfonyl)imide([PYR14][TFSI]), 1-ethyl-3-methylimidazolium, bis [(trifluoromethyl) sulfonyl]imide ([C2mim][TFSI]), 1-ethyl-3-methylimidazolium bis(fluorosulfonyl)imide([C2mim][FSI]), 1-butyl-3-methylimidazolium bis(trifluoromethylsulfonyl)imide(C4mim][TFSI]), 1-butyl-3-methyl-imidazolium bis(fluorosulfonyl)imide(C4mim][FSI]), or the like, or combinations thereof. One or more nanomaterials may also be included in the polymeric ion conductive layer 114 to enhance ionic conductivity and/or increase a mechanical strength thereof. Illustrative nanomaterials may be or include, but are not limited to, SiO₂, ZrO₂, Al₂O₃, LiLaTiO₃, or the like, or any combination thereof.

In one implementation, the difference between a Hansen Solubility Parameter of the polymer and a Hansen Solubility Parameter of the plasticizer of the polymeric ion conductive layer 114 may be greater than 0 and less than or equal to about 5, less than or equal to about 4.5, less than or equal to about 4, less than or equal to about 3.8, less than or equal to about 3.5, less than or equal to about 3, or less than or equal to about 2.5. The difference between a Hansen Solubility Parameter of the polymer and a Hansen Solubility Parameter of the plasticizer of the polymeric ion conductive layer 114 may also be greater than 0, greater than 0.5, or greater than 1 and less than or equal to about 5, less than or equal to about 4.5, less than or equal to about 4, less than or equal to about 3.8, less than or equal to about 3.5, less than or equal to about 3, or less than or equal to about 2.5. As used herein, the Hansen Solubility Parameter may be determined by HSPiP version 5.3.04 software and is used to predict if two or more materials are soluble and/or compatible with one another. Further, as used herein, a difference between a Hansen Solubility Parameter of a first material or substance and a Hansen Solubility Parameter of a second material or substance, may be referred to as an HSP Distance or “Ra”.

Laminates including the electrochromic device 100 described herein are also described. The laminates and/or the electrochromic device 100 described herein may be utilized in or as a window, a glass panel, a glazing, and/or an energy harvesting structural laminated glazing unit (LGU), optical shutters, color changing or changeable eyewear, welding visors, in various applications and/or industries including, but not limited to, architectural, vehicle, or transportation application and industries. Illustrative applications may be or include, but are not limited to, an automobile or a locomotive windshield, sidelam, rear window or sunroof, an airplane window or canopy, windows in a residential or commercial building, balustrades, balconies and stairs, a decorative panel or covering for walls, columns, an elevator, other architectural applications, a cover for signs, a display, an appliance, an electronic device, furniture, or the like. As used herein, the term “glazing” or “laminate” may refer to a transparent, semi-transparent, translucent, or opaque window, panel, wall, or other structure, or a portion/part thereof having at least one optically transparent sheet (e.g., rigid outer ply, glass sheet, polymeric sheet, etc.) laminated or otherwise coupled with another optically transparent sheet via an interlayer. For example, the laminate may be a clear or tinted laminated glass. The laminates may have a transmittance to visible light of greater than about 80%, and preferably greater than about 85%, and a switching speed of less than 5 min, less than 1 min, or less than 30 sec.

The following numbered paragraphs are directed to one or more exemplary variations of the subject matter of the application:

1. A polymeric ion conductive layer for an electrochromic device, comprising: a polymer comprising a Shore hardness of greater than 80 A; an electrolyte dispersed in the polymer; and a plasticizer dispersed in the polymer, wherein the polymeric ion conductive layer comprises no creep as measured at about 85° C.

2. The polymeric ion conductive layer of paragraph 1, wherein the polymer comprises a Shore hardness of greater than 87 A.

3. The polymeric ion conductive layer of paragraph 1 or 2, wherein the polymer comprises a Shore hardness of greater than or equal to 55 D.

4. The polymeric ion conductive layer of any one of paragraphs 1 to 3, wherein the polymer comprises a Shore hardness of greater than or equal to 60 D.

5. The polymeric ion conductive layer of any one of paragraphs 1 to 4, wherein the polymer comprises a Shore hardness of greater than or equal to 67 D.

6. The polymeric ion conductive layer of any one of paragraphs 1 to 5, wherein the polymer comprises a Shore hardness of greater than or equal to 72 D.

7. The polymeric ion conductive layer of any one of paragraphs 1 to 6, wherein the polymer comprises a Shore hardness of greater than or equal to 80 D.

8. The polymeric ion conductive layer of any one of paragraphs 1 to 7, wherein the polymeric ion conductive layer exhibits no creep as measured at about 85° C. for at least 24 hours.

9. The polymeric ion conductive layer of any one of paragraphs 1 to 8, wherein the polymeric ion conductive layer comprises an ionic conductivity of greater than or equal to about 1E-5 Siemens/cm (S/cm), greater than or equal to about 3.5E-5 S/cm, greater than or equal to about 4E-5 S/cm, greater than or equal to about 1E-4 S/cm, greater than or equal to about 2E-4 S/cm, greater than or equal to about 3E-4 S/cm.

10. The polymeric ion conductive layer of any one of paragraphs 1 to 9, wherein the polymeric ion conductive layer comprises a light transmission, as measured according to reference test ASTM-D1003, of greater than or equal to about 80%.

11. The polymeric ion conductive layer of any one of paragraphs 1 to 10, wherein the polymeric ion conductive layer comprises a haze, as measured according to reference test ASTM-D1003, of less than 3%.

12. The polymeric ion conductive layer of any one of paragraphs 1 to 11, wherein the polymeric ion conductive layer comprises a haze, as measured according to reference test ASTM-D1003, of less than 2%.

13. The polymeric ion conductive layer of any one of paragraphs 1 to 12, wherein the polymeric ion conductive layer comprises a peel strength of greater than 25 N/mm, as measured according to ASTM D3167.

14. The polymeric ion conductive layer of any one of paragraphs 1 to 13, wherein the polymer comprises a thermoplastic polymer.

15. The polymeric ion conductive layer of any one of paragraphs 1 to 14, wherein the polymer comprises a thermoplastic polyurethane.

16. The polymeric ion conductive layer of paragraph 15, wherein the thermoplastic polyurethane comprises an aliphatic polyether thermoplastic polyurethane.

17. The polymeric ion conductive layer of paragraph 15, wherein the thermoplastic polyurethane comprises a blend of two or more aliphatic polyether thermoplastic polyurethanes.

18. The polymeric ion conductive layer of any one of paragraphs 1 to 17, wherein the electrolyte comprises a lithium salt.

19. The polymeric ion conductive layer of paragraph 18, wherein the lithium salt comprises one or more of lithium chloride (LiCl), lithium fluoride (LiF), lithium iodide (LiI), lithium nitrate (LiNO₃), lithium perchlorate (LiClO₄), lithium tetrafluoroborate (LiBF₄), lithium hexafluorophosphate (LiPF₆), lithium hexafluoroarsenat (V) (LiAsF₆), lithium triflate, lithium imide, lithium bis(trifluoromethanesulfonyl)imide (LiTFSI) salt, lithium 2-trifluoromethyl-4,5-dicyanoimidazolide (LiTDI), or a combination thereof.

20. The polymeric ion conductive layer of any one of paragraphs 1 to 19, wherein the plasticizer is present in an amount of greater than or equal to about 40 wt %, based on the total weight of the polymeric ion conductive layer.

21. The polymeric ion conductive layer of any one of paragraphs 1 to 20, wherein the plasticizer is present in an amount of greater than or equal to about 42 wt %, based on the total weight of the polymeric ion conductive layer.

22. The polymeric ion conductive layer of any one of paragraphs 1 to 21, wherein the plasticizer is present in an amount of greater than or equal to about 45 wt % to about 65 wt %, based on the total weight of the polymeric ion conductive layer.

23. The polymeric ion conductive layer of any one of paragraphs 1 to 22, wherein a difference between a Hansen Solubility Parameter of the polymer and a Hansen Solubility Parameter of the plasticizer is less than or equal to about 5.

24. The polymeric ion conductive layer of any one of paragraphs 1 to 23, wherein a difference between a Hansen Solubility Parameter of the polymer and a Hansen Solubility Parameter of the plasticizer is less than or equal to about 3.8.

25. The polymeric ion conductive layer of any one of paragraphs 1 to 24, wherein the plasticizer comprises one or more of propylene carbonate, ethylene carbonate, triethylene glycol bis(2-ehtylhexanoate) (TEG-EH), or any combination thereof.

26. The polymeric ion conductive layer of paragraph 25, wherein the plasticizer comprises a combination of propylene carbonate and triethylene glycol bis(2-ehtylhexanoate) (TEG-EH).

27. The polymeric ion conductive layer of paragraph 25, wherein the plasticizer comprises a combination of ethylene carbonate, propylene carbonate, and triethylene glycol bis(2-ehtylhexanoate) (TEG-EH).

28. An electrochromic device, comprising a first optically transparent layer, a second optically transparent layer, and electrochromic layers interposed between the first and second optically transparent layers, wherein the electrochromic layers comprise the polymeric ion conductive layer of any one of paragraphs 1 to 27.

### EXAMPLES

The examples and other implementations described herein are exemplary and not intended to be limiting in describing the full scope of compositions and methods described herein. Equivalent changes, modifications, and variations of specific implementations, materials, compositions, and methods may be made within the scope of the implementations or embodiments described herein, with substantially similar results.

### Example 1

Exemplary polymeric ion conductive interlayers (1)-(8) were prepared and evaluated. Specifically, exemplary polymeric ion conductive interlayers (1)-(8) having a thickness of about 0.015 inches (about 0.381 mm) were prepared by combining a thermoplastic polyurethane having a Shore hardness of about 80 A with varying amounts of a plasticizer according to Table 1. Each of the polymeric ion conductive interlayers (1)-(8) was evaluated for ionic conductivity, light transmission, haze, and creep. Ion conductivity was measured via electrochemical impedance spectroscopy that evaluated between a starting frequency of about 1 MHz and an ending frequency of about 1 Hz at a sampling interval of about 1 second(s) using a potentiostat commercially available from Admiral instruments of Tempe, AZ. Light transmission and haze were measured according to reference test ASTM-D1003 of the American Society for Testing and Materials (ASTM).

Creep was evaluated on post-autoclaved laminates prepared from two glass substrates or panels, one measuring 4″×3″ and the other measuring 3″×3″, coupled or laminated with one another via each of the respective polymeric ion conductive interlayers (1)-(8). The laminates were suspended by securing a first glass substrate (4″×3″) while allowing the second glass substrate (3″×3″) to freely slide under its own weight. The laminates were evaluated in a convection oven maintained at a temperature of about 85° C. for about 24 hours. The results are summarized in Table 2.

TABLE 1
Polymeric Ion Conductive Interlayers (1)-(8)

| Component | (1) | (2) | (3) | (4) | (5) | (6) | (7) | (8) |
|---|---|---|---|---|---|---|---|---|
| TPU (80A | Bal. | Bal. | Bal. | Bal. | Bal. | Bal. | Bal. | Bal. |
| Hardness)¹ | | | | | | | | |
| (wt %) | | | | | | | | |
| Plasticizer² | 0 | 5 | 10 | 15 | 22 | 29 | 35 | — |
| (wt %) | | | | | | | | |
| Plasticizer³ | — | — | — | — | — | — | — | 35 |
| (wt %) | | | | | | | | |
| Total | 100 | 100 | 100 | 100 | 100 | 100 | 100 | 100 |
| Components | | | | | | | | |
| (wt %) | | | | | | | | |

¹Estane AG-8451 resin: aliphatic polyether TPU having a Shore hardness of about 80A and containing an adhesion promoter.
²Plasticizer blend including 66/34% v/v propylene carbonate and triethylene glycol bis(2-ethylhexanoate) (TEG-EH) and 1M Lithium bis(trifluoromethanesulfonyl)imide (LiTFSI) salt.
³Plasticizer blend including 30/30/40% v/v ethylene carbonate, propylene carbonate, and TEG-EH and 1M LiTFSI salt.

TABLE 2
Properties of Ion Conductive Interlayers (1)-(8)

| | (1) | (2) | (3) | (4) | (5) | (6) | (7) | (8) |
|---|---|---|---|---|---|---|---|---|
| Ionic | — | — | — | — | — | — | 1.31E−5 | — |
| Conduc- | | | | | | | | |
| tivity | | | | | | | | |
| (S/cm) | | | | | | | | |
| Light | 92.9² | 91.8² | 93.1² | 93.0² | 92.7² | 93.2² | 84³ | — |
| Trans- | | | | | | | | |
| mission | | | | | | | | |
| (%) | | | | | | | | |
| Haze | 1.08 | 1.21 | 0.89 | 1.05 | 0.95 | 1.02 | 1.86 | — |
| (%) | | | | | | | | |
| Δ Creep | 0 | 0 | 0 | 0 | 0 | 1 | Fail¹ | Fail¹ |
| Left | | | | | | | | |
| (mm) | | | | | | | | |
| Δ Creep | 0 | 0 | 0 | 0 | 0 | 1 | Fail¹ | Fail¹ |
| Right | | | | | | | | |
| (mm) | | | | | | | | |

¹Complete delamination.
²Laminated between clear borosilicate glass.
³Laminated between conductive glass.

As indicated in Table 2, the polymeric ion conductive interlayers (1)-(5) utilizing a combination of a TPU having a Shore hardness of about 80 A and the plasticizer in an amount from 0 wt % to about 22 wt % resulted in no creep. As further indicated in Table 2, the polymeric ion conductive interlayer (6) including about 29% of the plasticizer exhibited a measurable amount of creep of about 1 mm. The polymeric ion conductive interlayer (7) including about 35% of the plasticizer exhibited a total failure. Particularly, the free-sliding glass panel completely delaminated from the polymeric ion conductive interlayer (7). It was surprisingly and unexpectedly discovered that utilizing a different plasticizer in an amount of about 35%, as demonstrated in the polymeric ion conductive interlayer (8), also resulted in complete delamination of the free-sliding glass panel in less than three hours.

### Example 2

Exemplary polymeric ion conductive interlayers (9)-(13) were prepared and evaluated. Specifically, exemplary polymeric ion conductive interlayers (9)-(13) having a thickness of about 0.015 inches (about 0.381 mm) were prepared by combining a thermoplastic polyurethane blend with varying amounts of a plasticizer according to Table 3. The thermoplastic polyurethane blend included 50/50 wt % TEXIN® 8980 D and TECOFLEX® EG-72 D. TEXIN® 8980 D is an aliphatic polyether TPU having a Shore hardness of about 80 D, which is commercially available from Covestro LLC of Pittsburgh, PA. TECOFLEX EG-72 D is an aliphatic polyether TPU having a Shore hardness of about 67 D, which is commercially available from Lubrizol Corporation of Wickliffe, OH. The TPU resin blend had a combined Shore hardness of about 80 D/67 D, which is relatively higher than the 80 A hardness of the TPU of Example 1. Each of the polymeric ion conductive interlayers (9)-(13) was evaluated for ionic conductivity, light transmission, haze, and creep according to the same procedure as Example 1. The results are summarized in Table 4.

TABLE 3
Polymeric Ion Conductive Interlayers (9)-(13)

| Component | (9) | (10) | (11) | (12) | (13) |
|---|---|---|---|---|---|
| TPU (80D/67D Hardness)¹ | Bal. | Bal. | Bal. | Bal. | Bal. |
| (wt %) | | | | | |
| Plasticizer² | 35 | 40 | 45 | 50 | — |
| (wt %) | | | | | |
| Plasticizer³ | — | — | — | — | 35 |
| (wt %) | | | | | |
| Total Components | 100 | 100 | 100 | 100 | 100 |
| (wt %) | | | | | |

¹TPU resin blend including 50/50 wt % TEXIN ® 8980D and TECOFLEX ® EG-72D.
²Plasticizer blend including 66/34% v/v propylene carbonate and triethylene glycol bis(2-ethylhexanoate) (TEG-EH) and 1M Lithium bis(trifluoromethanesulfonyl)imide (LiTFSI) salt.
³Plasticizer blend including 30/30/40% v/v ethylene carbonate, propylene carbonate, and TEG-EH and 1M LiTFSI salt.

TABLE 4
Properties of Ion Conductive Interlayers (9)-(13)

| | (9) | (10) | (11) | (12) | (13) |
|---|---|---|---|---|---|
| Ionic Conductivity | 3.61E−6 | — | — | 2.21E−4 | 1.66E−6 |
| (S/cm) | | | | | |
| Light Transmission | 83.1² | 92.9¹ | 93.0¹ | 83.2² | 78.8² |
| (%) | | | | | |
| Haze | 2.12 | 1.49 | 1.19 | 1.39 | 2.17 |
| (%) | | | | | |
| Δ Creep Left | 0 | 0 | 0 | 0 | 0 |
| (mm) | | | | | |
| Δ Creep Right | 0 | 0 | 0 | 0 | 0 |
| (mm) | | | | | |

¹Laminated between clear borosilicate glass.
²Laminated between conductive glass.

As indicated in Table 4, the polymeric ion conductive interlayer (9) including about 35% of the plasticizer exhibited no creep as compared to the polymeric ion conductive interlayer (7), which also included about 35% of the same plasticizer. It was observed that the polymeric ion conductive interlayers (9)-(12) were relatively stiffer than the polymeric ion conductive interlayers (1)-(8) of Example 1. However, as further indicated in Table 4, the ionic conductivity of the polymeric ion conductive interlayer (9) was about 3.61E-6 S/cm, which was approximately a third of the ionic conductivity observed in the polymeric ion conductive interlayer (7) of Example 1. It was surprisingly and unexpectedly discovered that utilizing a different plasticizer in an amount of about 35 wt %, as demonstrated in the polymeric ion conductive interlayer (13), provided results that were parity or comparable with the polymeric ion conductive interlayers (9)-(12); and thus, exhibited no creep. It was further surprisingly and unexpectedly discovered that the polymeric ion conductive interlayer (12), which included about 50 wt % of the plasticizer exhibited a significant increase in ion conductivity as compared to the polymeric ion conductive interlayer (9). Particularly, it was demonstrated that the polymeric ion conductive interlayer (12) exhibited an ion conductivity of about 17× greater than the polymeric ion conductive interlayer (7) and about 61× greater than the polymeric ion conductive interlayer (9). It should be appreciated that utilizing a TPU having a relatively greater Shore hardness reduces or eliminates creep, and may decrease ionic conductivity. As such, the ability to increase the ionic conductivity presents a significant improvement for the polymeric ion conductive interlayers while maintaining the improved creep with the TPU having the relatively greater Shore hardness.

### Example 3

Exemplary polymeric ion conductive interlayers (14)-(15) were prepared and evaluated. Specifically, exemplary polymeric ion conductive interlayers (14)-(15) having a thickness of about 0.015 inches (about 0.381 mm) were prepared by combining a thermoplastic polyurethane with varying amounts of a plasticizer according to Table 5. The thermoplastic polyurethane was ESTANE® ALR TPU, an aliphatic based TPU having a Shore hardness of about 60 D, which is commercially available from Lubrizol Corporation of Wickliffe, OH. Each of the polymeric ion conductive interlayers (14)-(15) was evaluated for ionic conductivity, light transmission, haze, and creep according to the same procedure as Example 1. The results are summarized in Table 6.

TABLE 5
Polymeric Ion Conductive Interlayers (14)-(15)

| Component | (14) | (15) |
|---|---|---|
| TPU (60D Hardness)¹ | Bal. | Bal. |
| (wt %) | | |
| Plasticizer² | 50 | 50 |
| (wt %) | | |
| Total Components | 100 | 100 |
| (wt %) | | |

¹Estane ALR CLC60D: aliphatic polyether TPU having a Shore hardness of about 60D.
²Plasticizer blend including 66/34% v/v propylene carbonate and triethylene glycol bis(2-ethylhexanoate) (TEG-EH) and 1M Lithium bis(trifluoromethanesulfonyl)imide (LiTFSI) salt.

TABLE 6
Properties of Ion Conductive Interlayers (14)-(15)

| | (14) | (15) |
|---|---|---|
| Ionic Conductivity | 1.274E−4 | 1.580E−4 |
| (S/cm) | | |
| Light Transmission | 83.9¹ | 84.1¹ |
| (%) | | |
| Haze | 1.82 | 1.28 |
| (%) | | |
| Δ Creep Left | 0 | 0 |
| (mm) | | |
| Δ Creep Right | 0 | 0 |
| (mm) | | |

¹Laminated between conductive glass.

As indicated in Table 6, the polymeric ion conductive interlayers (14) and (15), which utilized a TPU having a Shore hardness of about 60 D also exhibited no creep. The polymeric ion conductive interlayers (14) and (15) also exhibited ionic conductivities in the same magnitude as the polymeric ion conductive interlayer (12).

### Example 4

Exemplary polymeric ion conductive interlayers (16)-(20) were prepared and evaluated. Specifically, exemplary polymeric ion conductive interlayers (16)-(20) having a thickness of about 0.015 inches (about 0.381 mm) were prepared by combining a thermoplastic polyurethane with varying amounts of a plasticizer according to Table 7. The thermoplastic polyurethane utilized for the polymeric ion conductive interlayers (16)-(18) was TEXIN® 8955DE, an aliphatic polyether based TPU having a Shore hardness of about 55 D, which is commercially available from Covestro LLC of Pittsburgh, PA. The thermoplastic polyurethane utilized for the polymeric ion conductive interlayer (19) and (20) was ELASTOLLAN® L760 D, an aliphatic polyester based TPU having Shore hardness of about 60 D, which is commercially available from BASF of Ludwigshafen, Germany. Each of the polymeric ion conductive interlayers (16)-(20) was evaluated for ionic conductivity, light transmission, haze, and creep according to the same procedure as Example 1. The results are summarized in Table 8.

TABLE 7
Polymeric Ion Conductive Interlayers (16)-(20)

| Component | (16) | (17) | (18) | (19) | (20) |
|---|---|---|---|---|---|
| TPU (55D Hardness)¹ | Bal. | Bal. | Bal. | — | — |
| (wt %) | | | | | |
| TPU (60D Hardness)² | — | — | — | Bal. | Bal. |
| Plasticizer³ | 40 | 45 | 50 | 45 | 50 |
| (wt %) | | | | | |
| Total Components | 100 | 100 | 100 | 100 | 100 |
| (wt %) | | | | | |

¹TEXIN 8955DE: aliphatic polyether TPU having a Shore hardness of about 55D.
²ELASTOLLAN L760D: aliphatic polyester TPU having a Shore hardness of about 60D.
³Plasticizer blend including 66/34% v/v propylene carbonate and triethylene glycol bis(2-ethylhexanoate) (TEG-EH) and 1M Lithium bis(trifluoromethanesulfonyl)imide (LiTFSI) salt

TABLE 8
Properties of Ion Conductive Interlayers (16)-(20)

| | (16) | (17) | (18) | (19) | (20) |
|---|---|---|---|---|---|
| Ionic | 8.83E−6 | 3.97E−5 | 2.12E−4 | 9.46E−6 | 3.23E−04 |
| Conductivity | | | | | |
| (S/cm) | | | | | |
| Light | 93.3 | 92.9 | 93.3 | 93.7 | 93.3 |
| Transmission | | | | | |
| (%) | | | | | |
| Haze | 1.0 | 1.2 | 1.2 | 1.1 | 1.3 |
| (%) | | | | | |
| Δ Creep | 0 | 0 | 0 | 0 | 0 |
| Left (mm) | | | | | |
| Δ Creep | 0 | 0 | 0 | 0 | 0 |
| Right (mm) | | | | | |

As indicated in Table 8, the polymeric ion conductive interlayers (16)-(20), which utilized or incorporated TPU having a Shore hardness of about 55 D or greater did not exhibit any creep. Additionally, it was surprisingly and unexpectedly discovered that the foregoing polymeric ion conductive interlayers (16)-(20) also exhibited ionic conductivities having relatively or substantially the same magnitude as the polymeric ion conductive interlayer (12).

While the devices, systems, and methods have been described in detail herein in accordance with certain preferred implementations thereof, many modifications and changes therein may be affected by those skilled in the art. Accordingly, the foregoing description should not be construed to be limited thereby but should be construed to include such aforementioned obvious variations and be limited only by the spirit and scope of the following claims.

What is claimed is:

1. A polymeric ion conductive layer for an electrochromic device, comprising:
a polymer comprising a Shore hardness of greater than 80 A;
an electrolyte dispersed in the polymer; and
a plasticizer dispersed in the polymer.

2. The polymeric ion conductive layer of claim 1, wherein the polymeric ion conductive layer comprises no creep as measured at about 85° C.

3. The polymeric ion conductive layer of claim 1, wherein the polymer comprises a Shore hardness of greater than 87 A.

4. The polymeric ion conductive layer of claim 1, wherein the polymer comprises a Shore hardness of greater than or equal to 55 D, greater than or equal to 60 D, greater than or equal to 67 D, greater than or equal to 72 D, or greater than or equal to 80 D.

5. The polymeric ion conductive layer of claim 1, wherein the polymeric ion conductive layer exhibits no creep as measured at about 85° C. for at least 24 hours.

6. The polymeric ion conductive layer of claim 1, wherein the polymeric ion conductive layer comprises an ionic conductivity of greater than or equal to about 1E-5 Siemens/cm (S/cm), greater than or equal to about 3.5E-5 S/cm, greater than or equal to about 4E-5 S/cm, greater than or equal to about 1E-4 S/cm, greater than or equal to about 2E-4 S/cm, or greater than or equal to about 3E-4 S/cm.

7. The polymeric ion conductive layer of claim 1, wherein the polymeric ion conductive layer comprises a light transmission, as measured according to reference test ASTM-D1003, of greater than or equal to about 80%.

8. The polymeric ion conductive layer claim 1, wherein the polymeric ion conductive layer comprises a haze, as measured according to reference test ASTM-D1003, of less than 3% or less than 2%.

9. The polymeric ion conductive layer of claim 1, wherein the polymeric ion conductive layer comprises a peel strength of greater than 25 N/mm, as measured according to ASTM D3167.

10. The polymeric ion conductive layer of claim 1, wherein the polymer comprises a thermoplastic polyurethane.

11. The polymeric ion conductive layer of claim 10, wherein the thermoplastic polyurethane comprises one or more aliphatic polyether thermoplastic polyurethanes.

12. The polymeric ion conductive layer of claim 1, wherein the electrolyte comprises a lithium salt.

13. The polymeric ion conductive layer of claim 12, wherein the lithium salt comprises one or more of lithium chloride (LiCl), lithium fluoride (LiF), lithium iodide (LiI), lithium nitrate (LiNO₃), lithium perchlorate (LiClO₄), lithium tetrafluoroborate (LiBF₄), lithium hexafluorophosphate (LiPF₆), lithium hexafluoroarsenat (V) (LiAsF₆), lithium triflate, lithium imide, lithium bis(trifluoromethanesulfonyl)imide (LiTFSI) salt, lithium 2-trifluoromethyl-4,5-dicyanoimidazolide (LiTDI), or a combination thereof.

14. The polymeric ion conductive layer of claim 1, wherein the plasticizer is present in an amount of greater than or equal to about 40 wt %, based on the total weight of the polymeric ion conductive layer.

15. The polymeric ion conductive layer of claim 1, wherein the plasticizer is present in an amount of greater than or equal to about 45 wt % to about 65 wt %, based on the total weight of the polymeric ion conductive layer.

16. The polymeric ion conductive layer of claim 1, wherein a difference between a Hansen Solubility Parameter of the polymer and a Hansen Solubility Parameter of the plasticizer is less than or equal to about 5.

17. The polymeric ion conductive layer of claim 1, wherein a difference between a Hansen Solubility Parameter of the polymer and a Hansen Solubility Parameter of the plasticizer is less than or equal to about 3.8.

18. The polymeric ion conductive layer of claim 1, wherein the plasticizer comprises one or more of propylene carbonate, ethylene carbonate, triethylene glycol bis(2-ehtylhexanoate) (TEG-EH), or any combination thereof.

19. The polymeric ion conductive layer of claim 18, wherein the plasticizer comprises:
a combination of propylene carbonate and triethylene glycol bis(2-ehtylhexanoate) (TEG-EH); or
a combination of ethylene carbonate, propylene carbonate, and triethylene glycol bis(2-ehtylhexanoate) (TEG-EH).

20. An electrochromic device, comprising a first optically transparent layer, a second optically transparent layer, and electrochromic layers interposed between the first and second optically transparent layers, wherein the electrochromic layers comprise the polymeric ion conductive layer of claim 1.
